(19) United States
(12) Patent Application Publication
(10) Pub. No.: US 2016/0153771 A1
(43) Pub. Date: Jun. 2, 2016

(54) Shape Measuring Device

(71) Applicant: Tokyo Seimitsu Co., Ltd., Tokyo (JP)

(72) Inventor: Tomohiro Aoto, Tokyo (JP)

(73) Assignee: Tokyo Seimitsu Co., Ltd., Tokyo (JP)

(21) Appl. No.: 14/807,439

(22) Filed: Jul. 23, 2015

Related U.S. Application Data
(63) Continuation of application No. PCT/JP2014/081400, filed on Nov. 27, 2014.

(51) Int. Cl. G01B 11/24; G01B 9/02

(52) U.S. Cl. CPC G01B 11/2441; G01B 9/0209; G01B 9/02062

(57) ABSTRACT

There is provided a shape measuring device surface capable of measuring a three-dimensional shape at high speed and with high accuracy. Low-coherence light emitted from a low-coherence light source enters a beam splitter through a collimator and is split into a measuring light and a reference light by the beam splitter. The measuring light is expanded and parallelized by a telecentric optical system so that a measuring object is irradiated with the measuring light. The measuring light reflected from the measuring object is combined with the reference light reflected from a CCP to be allow to interfere with each other to enter a photodetector. The photodetector includes light-receiving elements that are arranged in a matrix shape. A three-dimensional shape of a portion irradiated with the measuring light is measured based on a light intensity of an interference light detected at each of the light-receiving elements of the photodetector.

### BACKGROUND OF THE INVENTION

1. Field of the Invention

The present invention relates to a shape measuring device, and more particularly to a shape measuring device that precisely measures a three-dimensional shape of a surface of a measuring object by using the principle of low-coherence interference.

2. Description of the Related Art

As a method of precisely measuring a dimension of a measuring object in a non-contact manner, there is known a measurement method using the principle of low-coherence interference. In this method, a light emitted from a white light source with a wide spectrum wavelength, a so-called low-coherence light source, is split into a measuring light and a reference light so that the measuring object is irradiated with the measuring light, and the measuring light reflected from the measuring object and the reference light are allowed to interfere with each other. Then, intensity of the interference light is detected so that a dimension (a surface position) of the measuring object at a position irradiated with the measuring light is measured. Thus, in order to measure a three-dimensional shape of a surface in a wide range, it is required to change an irradiation position of the measuring light, that is, scanning of the measuring light or movement of the measuring object is required.

Japanese Patent Application Laid-Open No. 2010-43954 (hereinafter referred to as PTL 1) describes a technique of changing an irradiation position of a measuring light by changing a direction of the measuring light with a mirror (scanning mirror) capable of adjusting a direction of its reflection surface.

### SUMMARY OF THE INVENTION

However, PTL 1 has a disadvantage in that the measuring light is obliquely incident on a measuring surface because the direction of the measuring light is changed with the mirror. As a result, the intensity of the reflected measuring light decreases to deteriorate measurement sensitivity as well as increase a spot size of the measuring light with respect to a measuring object, whereby there is a problem in that measurement with high accuracy is impossible.

In addition, in order to measure a three-dimensional shape of a surface, the measuring object is required to be moved in a direction orthogonal (perpendicular) to a scanning direction by the measuring light. Thus, there is a disadvantage that the measurement becomes time-consuming.

Heretofore, in measurement using the principle of low-coherence interference, there have been used the following light sources as a low-coherence light source: a light source within a visible light range such as a halogen lamp and a light emitting diode (LED); and a light source whose center wavelength is within an infrared ray range such as a super luminescent diode (SLD), an amplified spontaneous emission (ASE) and a supercontinuum light source. Unfortunately, in this kind of light source, there is a problem in that the spot size of the measuring light condensed on a surface of the measuring object is limited by a diffraction limit of a wavelength of a light source. As a result, there is a problem that improvement of resolution in a lateral direction (a direction perpendicular to a propagation direction of the measuring light) is impossible.

The presently disclosed subject matter is made in light of the above-mentioned circumstances, and aims to provide a shape measuring device capable of measuring a three-dimensional shape of a surface of a measuring object at high speed and with high accuracy.

Solution to the problems is as follows.

(1) A first aspect is a shape measuring device that measures a three-dimensional shape of a surface of a measuring object, the shape measuring device including: a light source configured to radiate low-coherence light; a collimate optical system configured to convert the low-coherence light emitted from the light source into a parallel light; a light splitting unit configured to split the low-coherence light parallelized by the collimate optical system into a measuring light and a reference light; a reference light reflector configured to reflect the reference light emitted from the light splitting unit; a reference light path length change unit configured to change an optical path length of the reference light by moving the reference light reflector; a reference light reflector position detection unit configured to detect a position of the reference light reflector; a telecentric optical system configured to expand and parallelize the measuring light emitted from the light splitting unit, and irradiate the measuring object with the measuring light; a light interference unit configured to combine the reference light reflected from the reference light reflector and the measuring light reflected from the measuring object to allow the reference light and the measuring light to interfere with each other; a light detection unit including light-receiving elements arranged in a matrix shape, the light detection unit configured to receive an interference light of the measuring light and the reference light, emitted from the light interference unit; and a calculation unit configured to detect a position of the reference light reflector at a time when an intensity of the interference light becomes maximum for each of the light-receiving elements and calculate a three-dimensional shape of a surface of the measuring object irradiated with the measuring light.

According to the above aspect, the measuring light is expanded and parallelized by the telecentric optical system so that the measuring object is irradiated with the measuring light. Accordingly, it is possible to perpendicularly irradiate a wide range of the measuring object with the measuring light. The measuring light reflected from the measuring object enters the light interference unit through the telecentric optical system, and is combined with the reference light reflected from the reference light reflector to be allowed to interfere with each other, and then enters the light detection unit. The light detection unit includes light-receiving elements arranged in a matrix shape, and a light intensity is individually detected for each of the light-receiving elements. Thus, it is possible to acquire a three-dimensional shape of a surface of the measuring object irradiated with the measuring light by detecting a position of the reference light reflector at a time when the light intensity becomes maximum for each of the light-receiving elements. That is, since a surface height of a position corresponding to each of the light-receiving elements can be measured for each of the light-receiving elements, it is possible to acquire a shape of a portion irradiated by the measuring light by acquiring measurement information on all the light-receiving elements.

(2) A second aspect is a shape measuring device that measures a three-dimensional shape of a surface of a measuring object, the shape measuring device comprising: a light source configured to radiate low-coherence light; a collimate optical system configured to convert the low-coherence light emitted from the light source into a parallel light; a light splitting unit configured to split the low-coherence light parallelized by the collimate optical system into a measuring light and a reference light; a reference light reflector configured to reflect the reference light emitted from the light splitting unit; a telecentric optical system configured to expand and parallelize the measuring light emitted from the light splitting unit, and irradiate the measuring object with the measuring light; a light interference unit configured to combine the reference light reflected from the reference light reflector and the measuring light reflected from the measuring object to allow the reference light and the measuring light to interfere with each other; a light detection unit including light-receiving elements arranged in a matrix shape, the light detection unit configured to receive an interference light of the measuring light and the reference light, emitted from the light interference unit; a support body configured to movably support the collimate optical system, the light splitting unit, the reference light reflector, the light interference unit, the telecentric optical system, and the light detection unit, along an optical axis of the telecentric optical system; a measuring light path length change unit configured to change an optical path length of the measuring light by moving the support body; a support body position detection unit configured to detect a position of the support body; and a calculation unit configured to detect a position of the support body at a time when an intensity of the interference light becomes maximum for each of the light-receiving elements and calculate a three-dimensional shape of a surface of the measuring object irradiated with the measuring light.

According to the above aspect, the measuring light is expanded and parallelized by the telecentric optical system so that the measuring object is irradiated with the measuring light. Accordingly, it is possible to perpendicularly irradiate a wide range of the measuring object with the measuring light. The measuring light reflected from the measuring object enters the light interference unit through the telecentric optical system, and is combined with the reference light reflected from the reference light reflector to be allowed to interfere with each other, and then enters the light detection unit. The light detection unit includes light-receiving elements arranged in a matrix shape, and a light intensity is individually detected for each of the light-receiving elements. Thus, it is possible to acquire a three-dimensional shape of a surface of the measuring object irradiated with the measuring light by detecting a position of the support body at a time when the light intensity becomes maximum for each of the light-receiving elements.

(3) A third aspect is a shape measuring device that measures a three-dimensional shape of a surface of a measuring object, the shape measuring device comprising: a light source configured to radiate low-coherence light; a collimate optical system configured to convert the low-coherence light emitted from the light source into a parallel light; a light splitting unit configured to split the low-coherence light parallelized by the collimate optical system into a measuring light and a reference light; a reference light reflector configured to reflect the reference light emitted from the light splitting unit; a telecentric optical system configured to expand and parallelize the measuring light emitted from the light splitting unit, and irradiate the measuring object with the measuring light; a light interference unit configured to combine the reference light reflected from the reference light reflector and the measuring light reflected from the measuring object to allow the reference light and the measuring light to interfere with each other; a light detection unit including light-receiving elements arranged in a matrix shape, the light detection unit configured to receive an interference light of the measuring light and the reference light, emitted from the light interference unit; a support body configured to movably supports the measuring object along an optical axis of the telecentric optical system; a measuring light path length change unit configured to change an optical path length of the measuring light by moving the measuring object; a measuring object position detection unit configured to detect a position of the measuring object; and a calculation unit configured to detect a position of the measuring object at a time when an intensity of the interference light becomes maximum for each of the light-receiving elements and calculate a three-dimensional shape of a surface of the measuring object irradiated with the measuring light.

According to the above aspect, the measuring light is expanded and parallelized by the telecentric optical system so that the measuring object is irradiated with the measuring light. Accordingly, it is possible to perpendicularly irradiate a wide range of the measuring object with the measuring light. The measuring light reflected from the measuring object enters the light interference unit through the telecentric optical system, and is combined with the reference light reflected from the reference light reflector to be allowed to interfere with each other, and then enters the light detection unit. The light detection unit includes light-receiving elements arranged in a matrix shape, and a light intensity is individually detected for each of the light-receiving elements. Thus, it is possible to acquire a three-dimensional shape of a surface of the measuring object irradiated with the measuring light by detecting a position of the measuring object at a time when light intensity becomes maximum for each of the light-receiving elements.

(4) A fourth aspect provides an aspect of the shape measuring device of any one of first to third aspects described above, the shape measuring device according to the fourth aspect further including a correction information storage unit configured to store correction information on measurement data according to a change in the optical path length of the measuring light, caused by expanding and parallelizing the measuring light with the telecentric optical system, wherein the calculation unit is configured to correct calculated measurement data based on the correction information and acquire true measurement data.

According to the above aspect, deviation of measurement data due to a change in the optical path length of the measuring light, caused by expanding and parallelizing the measuring light, is corrected. Accordingly, it is possible to perform measurement with higher accuracy.

(5) A fifth aspect provides an aspect of the shape measuring device of any one of first to third aspects described above, the shape measuring device according to the fifth aspect further including a reference light path length correction unit that is arranged between the reference light reflector and the light interference unit, and that is configured to correct the optical path length of the reference light in accordance with a change in the optical path length of the measuring light, caused by expanding and parallelizing the measuring light with the telecentric optical system.

According to the above aspect, the optical path length of the reference light is corrected in accordance with a change in the optical path length of the measuring light, caused by expanding and parallelizing the measuring light. That is, the optical path length of the reference light is corrected so as to change the optical path length of the reference light by the same amount of variation as that of the optical path length of the measuring light. Accordingly, it is possible to perform measurement with higher accuracy.

(6) A sixth aspect is an aspect of the shape measuring device of any one of first to fifth aspects described above, in which the light source emits the low-coherence light whose center wavelength belongs to an ultraviolet light range.

According to the above aspect, there is used a light source that emits a low-coherence light whose center wavelength belongs to the ultraviolet light range (a wavelength of from 400 nm to 200 nm). Accordingly, it is possible to improve image surface resolution of the measuring light (about 0.5 μm), so that it is possible to improve resolution in the lateral direction. In addition, it is possible to prevent diffuse reflection from the measuring object by improving image surface resolution of the measuring light, so that it is possible to perform measurement with high sensitivity.

(7) A seventh aspect is an aspect of the shape measuring device of any one of first to sixth aspects, in which the light detection unit includes solid imaging elements, and a surface image of the measuring object is captured simultaneously with measurement of the three-dimensional shape.

According to the present aspect, the light detection unit is configured by solid imaging elements, such as a CCD, and a CMOS, and captures a surface image of a measuring object. Accordingly, it is possible to acquire image data on the surface measured along with data on a three-dimensional shape.

According to the presently disclosed subject matter, it is possible to measure a three-dimensional shape of a surface of a measuring object at high speed and with high accuracy.

### BRIEF DESCRIPTION OF THE DRAWINGS

FIG. 1 is a schematic block diagram showing a first embodiment of a shape measuring device.

FIG. 2 shows an example of a spectrum distribution of a light emitted from a low-coherence light source.

FIG. 3 is a schematic block diagram of a reference light scanning optical system.

FIG. 4 is a schematic block diagram of a light receiving surface of a photodetector.

FIG. 5 shows an example of an interference signal outputted from the photodetector.

FIG. 6 is a schematic block diagram showing a second embodiment of a shape measuring device.

FIG. 7 is a schematic block diagram showing another embodiment of a shape measuring device.

FIG. 8 is a schematic block diagram showing another embodiment of a shape measuring device.

### DETAILED DESCRIPTION OF THE EMBODIMENTS

Hereinafter, referring to accompanying drawings, a preferable embodiment of the presently disclosed subject matter will be described.

### First Embodiment

(Device Configuration)

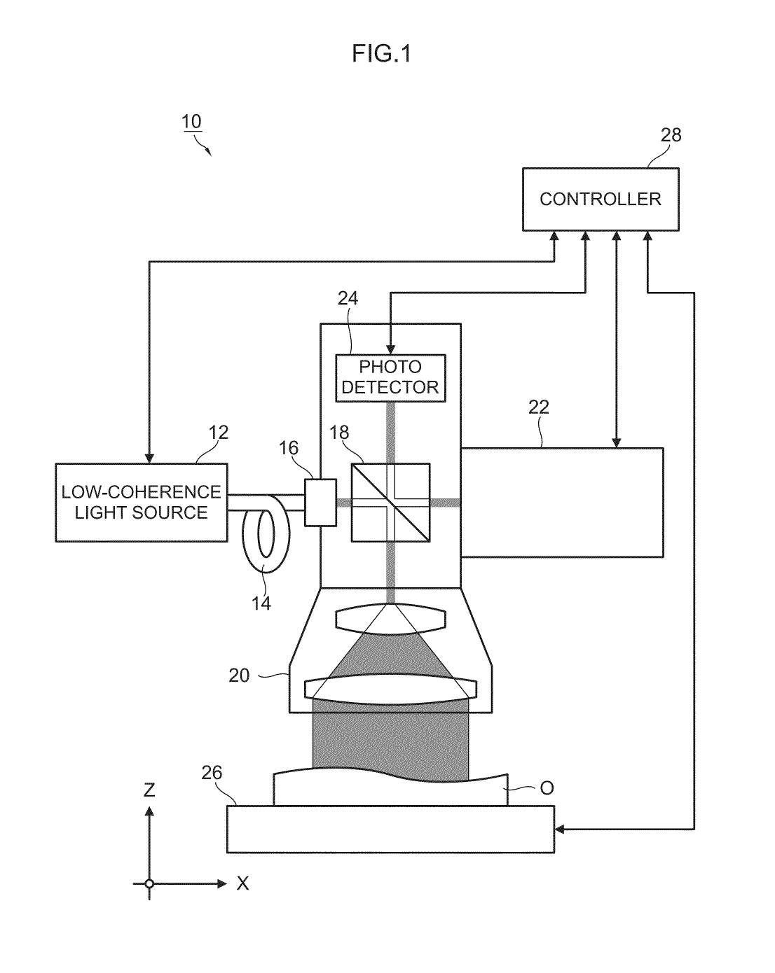

FIG. 1 a schematic block diagram showing a first embodiment of a shape measuring device in accordance with the presently disclosed subject matter.

As shown in FIG. 1, a shape measuring device 10 of the present embodiment mainly includes, a low-coherence light source 12, a light guide 14, a collimator 16, a beam splitter 18, a telecentric optical system 20, a reference light scanning optical system 22, a photodetector 24, a measuring object drive stage 26, and a controller 28.

The low-coherence light source 12 is a light source that emits a light (low-coherence light) having a short coherence length and a broadband wavelength.

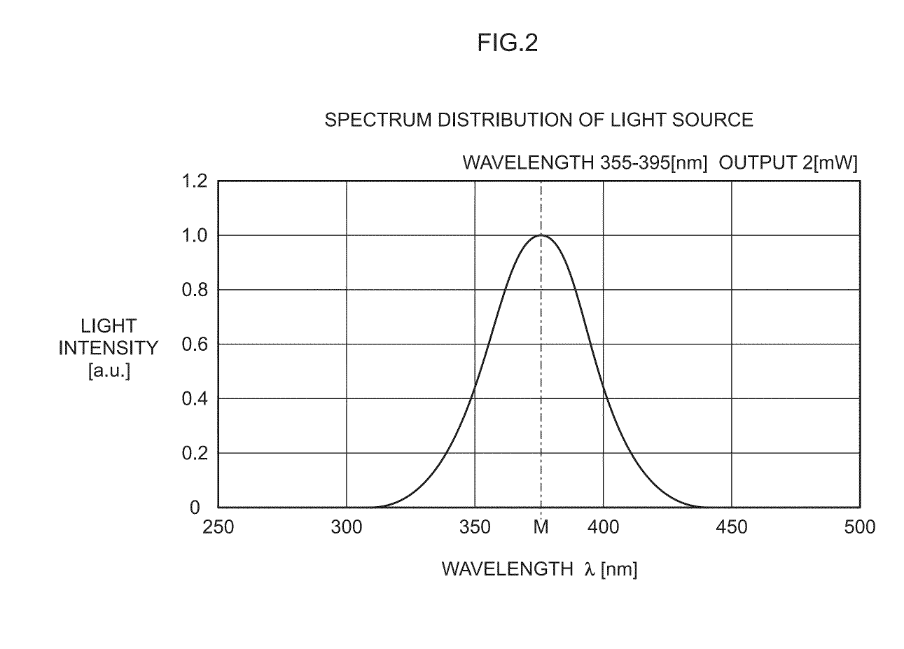

FIG. 2 shows an example of spectrum distribution of a light emitted from a low-coherence light source.

As shown in FIG. 2, an emission spectrum of the light emitted from the low-coherence light source 12 becomes an emission spectrum that has a certain extension centering a wavelength λ of M.

In particular, in the shape measuring device 10 of the present embodiment, there is used a light source whose center wavelength M is within the ultraviolet light range (a wavelength of from 400 nm to 200 nm). By using this kind of light source, it is possible to improve image surface resolution of the measuring light (about 0.5 μm), so that it is possible to improve resolution in the lateral direction.

As the low-coherence light source 12, there are available, for example, a xenon lamp, an ultraviolet laser light source, a light emitting diode (LED), and the like (a spectrum width of 50 nm or more is preferable).

The light guide 14 is composed of a flexible optical fiber and propagates the light emitted from the low-coherence light source 12 to the collimator 16.

The collimator 16 converts a diverging light emitted from the light guide 14 into a parallel light so that the parallel light enters the beam splitter 18.

The beam splitter 18 serves as light splitting means and light interference means, and splits the light emitted from the collimator 16 into a measuring light and a reference light (a function as light splitting means). The measuring light enters the telecentric optical system 20, and the reference light enters the reference light scanning optical system 22. In addition, the beam splitter 18 combines the light returning from the telecentric optical system 20 (i.e., the measuring light reflected from a measuring object O) with the light returning from the reference light scanning optical system 22 (i.e., the reference light reflected from a CCP 40) to allow them to optically interfere with each other (a function as the light interference means) and to enter the photodetector 24.

The telecentric optical system 20 serves to expand and parallelize the measuring light emitted from the beam splitter 18, as well as to improve image surface resolution of the measuring light to reduce aberration, such as distortion of the image surface. The measuring light is expanded and parallelized through the telecentric optical system 20 so that a surface of the measuring object O is irradiated with the measuring light (a surface of the measuring object O is irradiated with the measuring light with a size of from φ 60 mm to 100 mm, and an image surface resolution of 4.0 μm or more, for example).

Accordingly, it is possible to vertically irradiate a wide range of a surface of the measuring object O (measuring object surface) with the measuring light.

There is set a measurement area in which a three-dimensional shape of a surface is to be measured in an area to be irradiated with the measuring light.

The measuring light irradiated on a surface of the measuring object O through the telecentric optical system 20 is reflected on the surface of the measuring object O and returns to the beam splitter 18 through the telecentric optical system 20.

It is preferable that the telecentric optical system 20 is a both-side telecentric optical system, considering that the measuring light (image) and the reference light (image) are allowed to interfere (overlap) with each other in the beam splitter 18.

The reference light scanning optical system 22 changes the optical path length of the reference light emitted from the beam splitter 18.

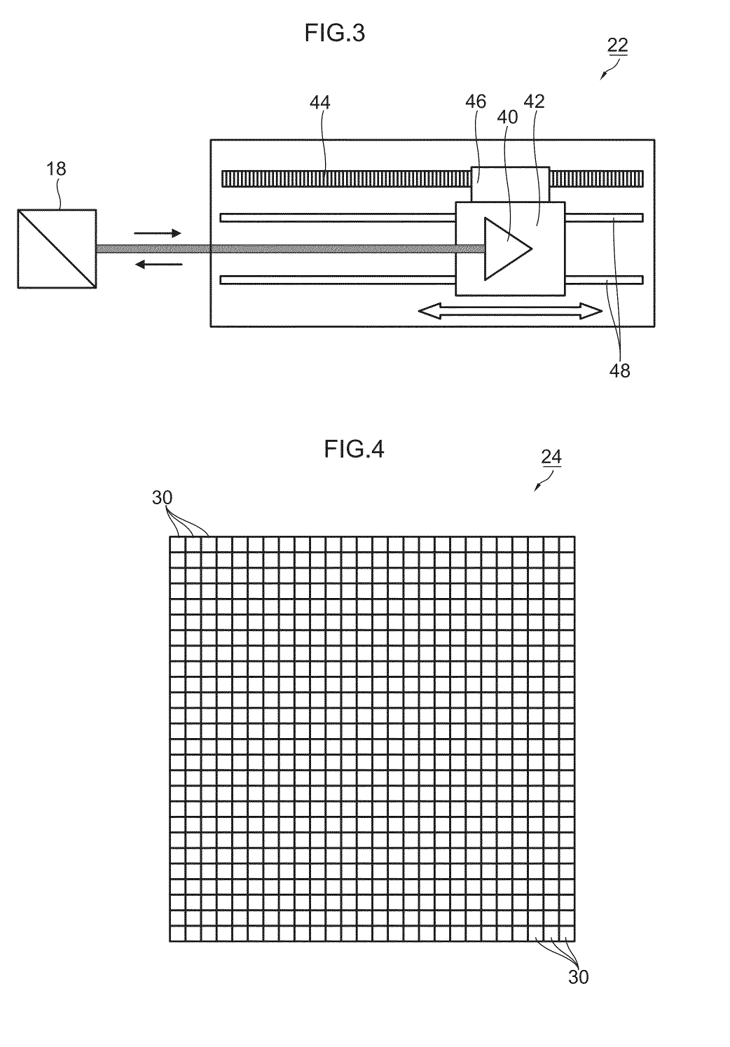

FIG. 3 is a schematic block diagram of a reference light scanning optical system.

As shown in FIG. 3, the reference light scanning optical system 22 mainly includes a corner cube prism (CCP) 40, a linear-motion stage 42, a linear scale 44, and a scale head 46.

The CCP 40 serves as a reference light reflector to reflect the reference light emitted from the beam splitter 18 so that the reference light enters the beam splitter 18.

The linear-motion stage 42 serves as reference light path length change means to move the CCP 40 to change the optical path length of the reference light. As shown in FIG. 3, the CCP 40 is provided in the linear-motion stage 42, and the linear-motion stage 42 is provided on a guide rails 48. The guide rails 48 are arranged so as to keep parallelism and concentricity with respect to an optical axis of the reference light emitted from the beam splitter 18. The linear-motion stage 42 is driven by drive means (not shown, such as a piezoelectric element, a voice coil motor, and an ultrasound motor) to reciprocate on the guide rails 48. The linear-motion stage 42 reciprocates on the guide rails 48 to allow the CCP 40 to reciprocate along the optical axis of the reference light emitted from the beam splitter 18. Accordingly, the optical path length of the reference light is changed.

The linear scale 44 and the scale head 46 constitute reference light reflector position detection means to detect a position of the CCP 40. The linear scale 44 is arranged so as to be able to detect a position of the linear-motion stage 42 that moves along the guide rails 48. The scale head 46 is provided in the linear-motion stage 42. As the linear-motion stage 42 moves, the scale head 46 moves along the linear scale 44. The scale head 46 reads positional information on the linear scale 44 to detect a position of the CCP 40. The positional information on the CCP 40 read by the scale head 46 is outputted to the controller 28.

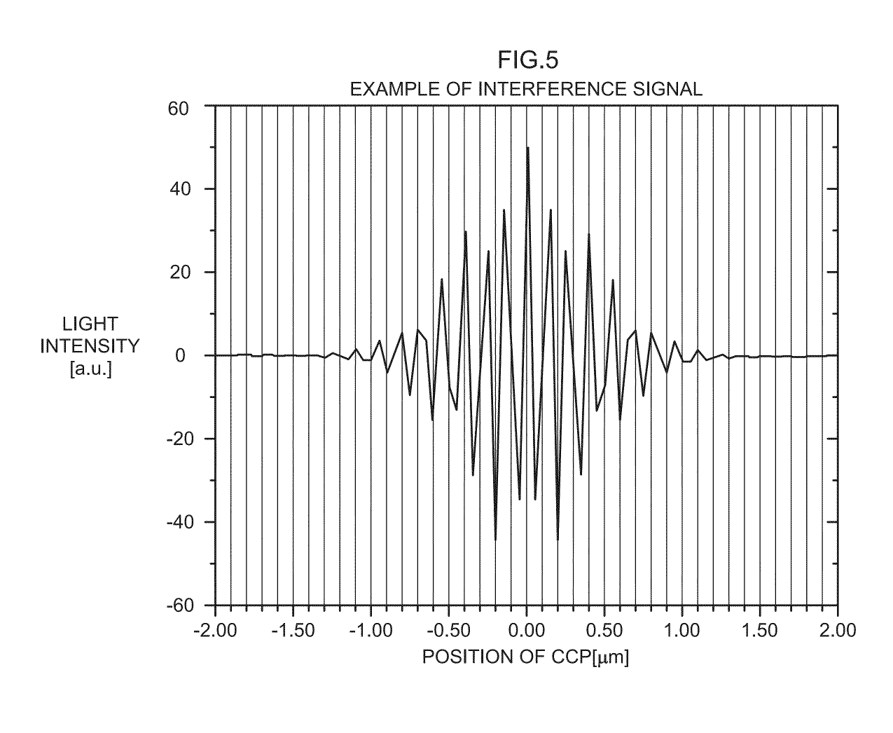

As shown in FIG. 4, the photodetector (light detection means) 24 is composed of a large number of light-receiving elements (pixels) 30 that are arranged in a matrix shape. Each of the light-receiving elements 30 accumulates an electric charge in accordance with intensity of light received. The photodetector 24 converts a signal charge accumulated in each of the light-receiving elements 30 into a signal voltage to output the signal voltage as an electric signal (interference signal). As the photodetector 24 having this kind of function, there is suitably used a solid imaging element, such as a charge coupled device (CCD) image sensor, and a complementary metal oxide semiconductor (CMOS) image sensor, for example.

The measuring light reflected from the measuring object O and the reference light reflected from the CCP 40 are combined by the beam splitter 18 to be allowed to optically interfere with each other, and then enter each of the light-receiving elements 30 of the photodetector 24.

Each of the light-receiving elements 30 of the photodetector 24 corresponds to each of the measurement points, which is set in a measurement area, in a one-to-one manner, so that an interference light of the measuring light reflected from each of the measurement points enters the corresponding light-receiving element 30. That is, the measurement area is set as an area from which the measuring light is reflected to allow an interference light of the reflected light to enter the photodetector 24, in an area irradiated with the measuring light. Thus, for example, if the photodetector 24 is composed of solid imaging elements, an imaging area of the solid imaging elements (an area can be imaged by the solid imaging elements) is set as a measurement area. Then, each of measurement points is set as an area that is formed by dividing the measurement area in accordance with arrangement of the light-receiving elements 30. Thus, for example, if the light-receiving elements 30 are arranged in an m-by-n matrix, each of divisions formed by dividing the measurement area in the m-by-n matrix is set as a measurement point.

Intensity of an interference light detected by each of the light-receiving elements 30 of the photodetector 24 changes, as the CCP 40 is moved. That is, since the intensity of the interference light changes in accordance with a difference between the optical path length of the reference light and that of the measuring light, when the CCP 40 is moved to change the optical path length of the reference light, the difference between the optical path length of the reference light and that of the measuring light changes so that the intensity of an interference light changes. Then, the intensity amplitude of the interference light becomes maximum when the difference between the optical path length of the reference light and that of the measuring light is zero.

The photodetector 24 performs sampling at a predetermined time interval, and convers the light amount (amount of light) detected at each sampling time into an electric signal (interference signal) and outputs the electric signal to the controller 28.

In the shape measuring device 10 of the present embodiment, since a light source whose center wavelength is within the ultraviolet light range is used as the low-coherence light source 12, it is preferable to use a detector with high sensitivity in the ultraviolet light range.

In addition, in a case where a light source whose center wavelength is within the ultraviolet light range is used as described above, it is possible to improve image surface resolution of the measuring light (it is possible to improve resolution in the lateral direction). Thus, it is preferable to use a detector with high resolution also (five million pixels or more) as the photodetector 24. Accordingly, it is possible to perform measurement with high resolution.

The measuring object drive stage 26 is a stage on which the measuring object O is to be mounted, and is provided so as to be movable in two directions orthogonal to each other (an X-direction (an X-direction in FIG. 1) and a Y-direction (a direction orthogonal to a paper-surface in FIG. 1)) (provided so as to be movable in an XY-plane). The measuring object drive stage 26 is driven by stage drive means (not shown) to be moved in the X-direction and the Y-direction (moved in the XY-plane).

A position of the measuring object drive stage 26 is detected by stage position detection means (not shown), and information on the detected position is outputted to the controller 28.

The measuring light emitted from the telecentric optical system 20 enters vertically (in a Z-direction) the measuring object drive stage 26 (enters vertically with respect to the XY-plane).

The controller 28 serves as the calculation means for calculating a dimension of the measuring object O, as well as serves as control means for integrally controlling operation of the whole of the shape measuring device 10. The controller 28 is constitute by a so-called personal computer (PC), and executes a predetermined program to achieve functions of the calculation means and the control means.

The controller 28 performs drive control of each unit, such as movement control of the measuring object drive stage 26, movement control of the CCP 40, and light emission control of the low-coherence light source 12.

In addition, the controller 28 calculates a three-dimensional shape of the measuring object O. That is, the controller 28 acquires an interference signal (intensity of an interference light) of each of the light-receiving elements 30 outputted from the photodetector 24, positional information on the CCP 40 outputted from the scale head 46, and positional information on the measuring object drive stage 26 outputted from the stage position detection means, and calculates a three-dimensional shape of a surface to be measured of the measuring object O on the basis of the information described above.

Specifically, a three-dimensional shape of a surface to be measured is calculated as follows.

Since the light emitted from the low-coherence light source 12 has short coherence length, interference fringes (white interference fringes) are detected only when a difference between the optical path length of the measuring light and that of the reference light is zero or around zero. When the optical path length of the measuring light and that of the reference light coincide with each other, or a difference between their the optical path lengths is zero, the interference fringes have maximum contrast. The contrast of the interference fringes is indicated as the intensity of the interference light detected by the photodetector 24, and changes in accordance with the position of the CCP 40, that is, the difference between the optical path length of the measuring light and that of the reference light, as shown in FIG. 5.

In dimensional measurement using the principle of low-coherence interference, first, the position of the CCP 40 at the time when the intensity of the interference light becomes maximum is acquired for a reference article (master) whose dimension is known, and next, the position of the CCP 40 at the time when the intensity of the interference light becomes maximum is acquired for the measuring object O. Then, a difference in the optical path length corresponding to a difference between acquired positions of the CCP 40 is acquired, and the acquired difference in the optical path length is added to the dimension of the reference article to acquire the dimension of the measuring object O.

In the shape measuring device 10 of the present embodiment, the light intensity of the interference light is detected by each of the light-receiving elements (pixels) 30 constituting the photodetector 24. Thus, by each of the light-receiving elements 30, the position of the CCP 40 at the time when the intensity of the interference light becomes maximum is acquired for the reference article, and the position of the CCP 40 at the time when the intensity of the interference light becomes maximum is acquired for the measuring object O. Then, the difference in the optical path length is acquired for each of the light-receiving elements 30, and the acquired difference in the optical path length is added to the dimension of the reference article so that the dimension is acquired for each of the light-receiving element 30. The dimension acquired for each of the light-receiving elements 30 shows the dimension of the corresponding measurement point. Thus, by acquiring the dimensions of all the measurement points, a three-dimensional shape of the measurement area is acquired.

Measurement of the reference article is performed before measurement of the measuring object O is performed. Then, information acquired by the measurement is stored in a storage device (not shown) in the controller 28.

(Operation)

Next, a measurement method of a three-dimensional shape of a surface of a measuring object by using the shape measuring device 10 of the present embodiment configured as above will be described.

As advance preparation of actually measuring the measuring object O, measurement of a reference surface is performed. The measurement of a reference surface is performed by setting the reference article whose dimension (surface position) is known on the measuring object drive stage 26 and performing measurement of a surface (reference surface) of the reference article. That is, the reference article is set on the measuring object drive stage 26, and the low-coherence light source 12 is turned on to irradiate the surface of the reference article with a measuring light. Then, the CCP 40 is moved and a position P0 of the CCP 40 at the time when an intensity of an interference light becomes maximum is detected.

Here, as described above, in the shape measuring device 10 of the present embodiment, since the interference light is received by each of the light-receiving elements 30 of the photodetector 24, the position PO of the CCP 40 at the time when the intensity of the interference light becomes maximum is detected for each of the light-receiving elements 30.

The controller 28 stores information on the position PO of the CCP 40 acquired for each of the light-receiving elements 30 in a storage device (not shown) in the controller 28, as reference positional information.

After the advance preparation above is completed, measurement of the measuring object O is performed.

The measuring object O is set on the measuring object drive stage 26 of the shape measuring device 10. After the measuring object O is set, an operator instructs the controller 28 to start the measurement.

When a start of the measurement is instructed, first, the controller 28 turns on the low-coherence light source 12. Accordingly, a light from the low-coherence light source 12 is split into a measuring light and a reference light by the beam splitter 18 so that a surface of the measuring object O is irradiated with the measuring light as well as the reference light enters the CCP 40. After reflected from the surface of the measuring object O the measuring light returns to the beam splitter 18, is combined with the reference light reflected from the CCP 40 to be allowed to interfere with each other, and enters the photodetector 24.

When the light emitted from the low-coherence light source 12 becomes steady, the controller 28 allows the drive means (not shown) of the linear-motion stage 42 to be driven to move (reciprocate) the CCP 40. As the CCP 40 is moved, the optical path length of the reference light is changed, whereby a difference between the optical path length of the reference light and that of the measuring light is changed.

The controller 28 acquires the positional information on the CCP 40 from the scale head 46, as well as an interference signal of each of the light-receiving elements 30 from the photodetector 24. Then, the controller 28 detects a position P of the CCP 40 at the time when the interference signal becomes maximum at each of the light-receiving elements 30.

Information on the position P of the CCP 40, detected for each of the light-receiving elements 30, is stored in the storage device (not shown) in the controller 28, as detected positional information.

The controller 28 acquires a difference between the detected position P and the reference position P0 for each of the light-receiving elements 30 to acquire a difference between the optical path length of the measuring light and that of the reference light, corresponding to the difference between the detected position P and the reference position P0. Then, the difference in the optical path length acquired is added to the surface position of the reference surface to determine the dimension (surface position) of the measuring object O for each of the light-receiving elements 30. Since the dimension acquired at each of the light-receiving elements 30 shows a dimension of the corresponding measurement point, the dimension of each of the measurement points can be acquired. By acquiring the dimensions of all the measurement points, the dimension of each of the measurement points in the measurement area can be acquired, and thus a three-dimensional shape of the measurement area is acquired.

As described above, according to the shape measuring device 10 of the present embodiment, a measuring light is expanded and parallelized through the telecentric optical system 20, and then a measuring object is irradiated with the measuring light. As a result, since a three-dimensional shape of a surface of the measuring object can be measured at a time, the three-dimensional shape of the surface can be measured at high speed.

In addition, since the measuring object O is irradiated with the measuring light through the telecentric optical system 20, it is possible to allow the measuring light to perpendicularly incident on the measuring surface. Accordingly, it is possible to prevent scattering caused by the measuring light obliquely incident on the measuring surface, so that measurement with high sensitivity can be performed.

Further, it is possible to improve image surface resolution of the measuring light by using a light source whose center wavelength is within the ultraviolet light range as the low-coherence light source 12. Accordingly, it is possible to enhance resolution in the lateral direction, so that measurement with high accuracy can be performed. In addition, in this way, it is possible to measure a fine shape, micro electro mechanical systems (MEMS), roughness, and the like.

In the example described above, although only one place in a surface of the measuring object O is measured, it is possible to measure a plurality of places by moving the measuring object drive stage 26 in the X-direction (or the Y-direction) to move the measuring object O to change a position of a measurement area with respect to the measuring object O.

### Second Embodiment

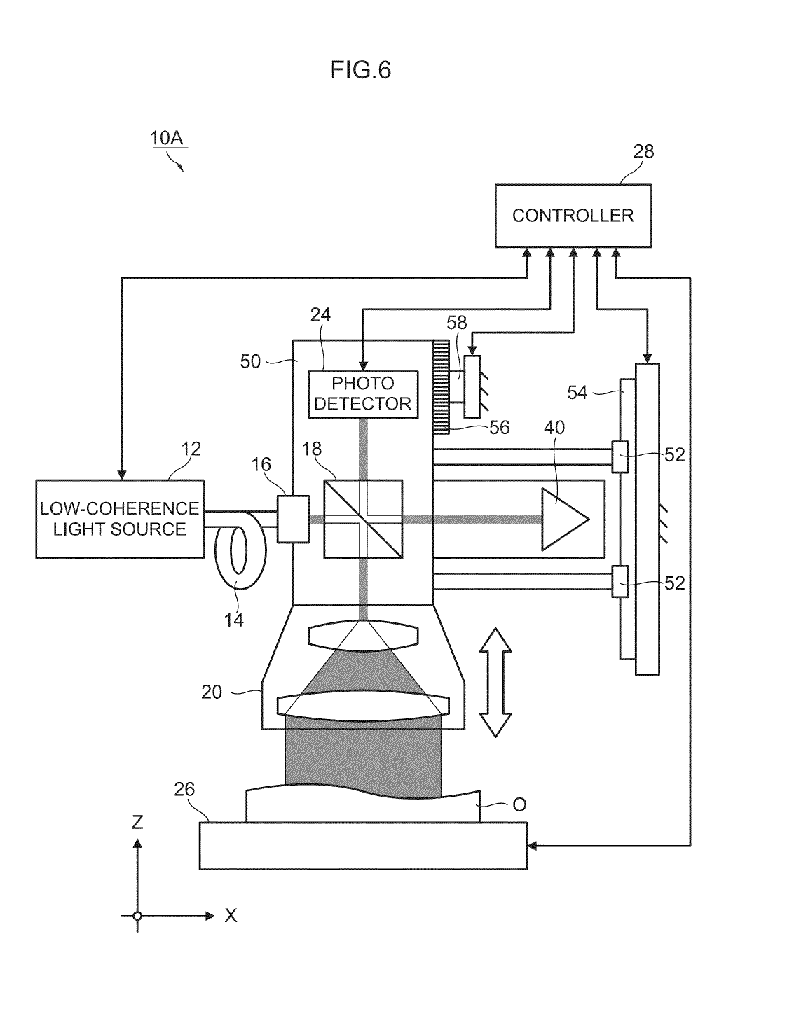

FIG. 6 a schematic block diagram showing a second embodiment of a shape measuring device in accordance with the presently disclosed subject matter.

The shape measuring device of the present embodiment is capable of changing a difference between the optical path length of a measuring light and that of a reference light by allowing the optical path length of reference light to be invariable and moving the whole of an optical system.

The shape measuring device of the present embodiment is essentially identical with the shape measuring device 10 of the first embodiment descried above, except that the optical path length of a reference light is constant and the whole of the optical system is movable. Thus, in the below, only a difference from the shape measuring device 10 of the first embodiment descried above will be described.

As shown in FIG. 6, in the shape measuring device 10A of the present embodiment, in order to reflect a reference light emitted from the beam splitter 18 to return to the beam splitter 18, the CCP (reference light reflector) 40 is arranged so as to be fixed at a predetermined position with respect to the beam splitter 18. Thus, the optical path length of the reference light is allowed to be invariable so as to be kept constant.

The collimator 16, the beam splitter 18, the telecentric optical system 20, the CCP 40, and the photodetector 24, which constitute an optical system, are provided in an optical system support frame (support body) 50.

The optical system support frame 50 is provided on guide rails 54 through sliders 52. The guide rails 54 are provided in a body frame (not shown) of the shape measuring device 10A. In addition, the guide rails 54 are provided so as to keep parallelism and concentricity with respect to an optical axis of the measuring light emitted from the telecentric optical system 20. The optical system support frame 50 is driven by drive means (not shown, such as a piezoelectric element, a voice coil motor, and an ultrasound motor) to reciprocate on the guide rails 54.

As the optical system support frame 50 reciprocates on the guide rails 54, the collimator 16, the beam splitter 18, the telecentric optical system 20, the CCP 40, and the photodetector 24, integrally move to change the optical path length of the measuring light. Accordingly, a difference between the optical path length of the measuring light and that of the reference light is changed.

A position of the optical system support frame 50 is detected by position detection means (support body position detection means) composed of a linear scale 56 and a scale head 58.

The linear scale 56 is provided in the optical system support frame 50, and is moved along with the optical system support frame 50. The scale head 58 is provided so as to be fixed to a body frame (not shown) of the shape measuring device 10A. The scale head 58 reads positional information on the linear scale 56 to detect a position of the optical system support frame 50. The positional information on the optical system support frame 50 read by the scale head 58 is outputted to the controller 28.

(Operation)

Next, a measurement method of a three-dimensional shape of a surface of a measuring object by using the shape measuring device 10A of the present embodiment configured as above will be described.

The shape measuring device 10 of the first embodiment described above is configured to move the CCP 40, acquire a position of the CCP 40 at the time when an intensity of an interference light becomes maximum and obtain a dimension of the measuring object O.

On the other hand, in the shape measuring device 10A of the present embodiment, the optical system support frame 50 is moved to acquire a position of the optical system support frame 50 at the time when intensity of an interference light becomes maximum and obtain the dimension of the measuring object O. Specifically, measurement is performed as follows.

As with the shape measuring device 10 of the first embodiment described above, measurement of a reference surface is performed as advance preparation. The measurement of a reference surface is performed by setting a reference article whose dimension (surface position) is known in the measuring object drive stage 26 so that measurement of a surface of the reference article (reference surface) is performed. That is, the reference article is set in the measuring object drive stage 26, and the low-coherence light source 12 is turned on to irradiate the surface of the reference article with a measuring light. Then, the optical system support frame 50 is moved and a position PO of the optical system support frame 50 at the time when the intensity of the interference light becomes maximum is detected. In the photodetector 24, since the interference light is received by each of the light-receiving elements 30, the position P0 of the optical system support frame 50 at the time when intensity of the interference light becomes maximum is detected for each of the light-receiving elements 30.

The controller 28 stores information on the position P0 of the optical system support frame 50 acquired for each of the light-receiving elements 30 in a storage device (not shown) in the controller 28, as reference positional information.

After the advance preparation above is completed, measurement of the measuring object O is performed.

The measuring object O is set in the measuring object drive stage 26 of the shape measuring device 10. After the measuring object O is set, an operator instructs the controller 28 to start the measurement.

When a start of the measurement is instructed, first, the controller 28 turns on the low-coherence light source 12. Accordingly, a light from the low-coherence light source 12 is split into a measuring light and a reference light by the beam splitter 18 so that a surface of the measuring object O is irradiated with the measuring light as well as the reference light enters the CCP 40. After reflected from the surface of the measuring object O, the measuring light returns to the beam splitter 18 to be combined with the reference light reflected from the CCP 40 to be allowed to interfere with each other to enter the photodetector 24.

When the light emitted from the low-coherence light source 12 becomes steady, the controller 28 allows drive means (not shown) of the optical system support frame 50 to be driven to move (reciprocate) the optical system support frame 50. As the optical system support frame 50 is moved, a difference between the optical path length of the reference light and that of the measuring light is changed.

The controller 28 acquires the positional information on the optical system support frame 50 from the scale head 58, as well as an interference signal of each of the light-receiving elements 30 from the photodetector 24. Then, the controller 28 detects a position P of the optical system support frame 50 at the time when the interference signal becomes maximum at each of the light-receiving elements 30.

Information on the position P of the optical system support frame 50, detected for each of the light-receiving elements 30, is stored in the storage device (not shown) in the controller 28, as detected positional information.

The controller 28 acquires a difference between the detected position P and the reference position P0 for each of the light-receiving elements 30 to acquire a difference between the optical path length of the reference light and that of the measuring light, corresponding to the difference between the positions above. Then, the difference in the optical path length acquired is added to the surface position of the reference surface to determine the dimension (surface position) of the measuring object O for each of the light-receiving elements 30. Since the dimension acquired at each of the light-receiving elements 30 shows a dimension of the corresponding measurement point, the dimension of each of the measurement points can be acquired. By acquiring the dimensions of all the measurement points, the dimension of each of the measurement points in the measurement area can be acquired, and thus a three-dimensional shape of the measurement area is acquired.

As described above, it is possible to measure a three-dimensional shape of a surface also by moving the whole of an optical system, so that the three-dimensional shape of the surface can be measured at high speed.

In addition, instead of a configuration in which only a part of an optical system is moved (such as a configuration in which only the telecentric optical system 20 is moved), the configuration in which the whole of the optical system is moved enables occurrence of image surface distortion and the like to be prevented so that measurement with high accuracy can be performed.

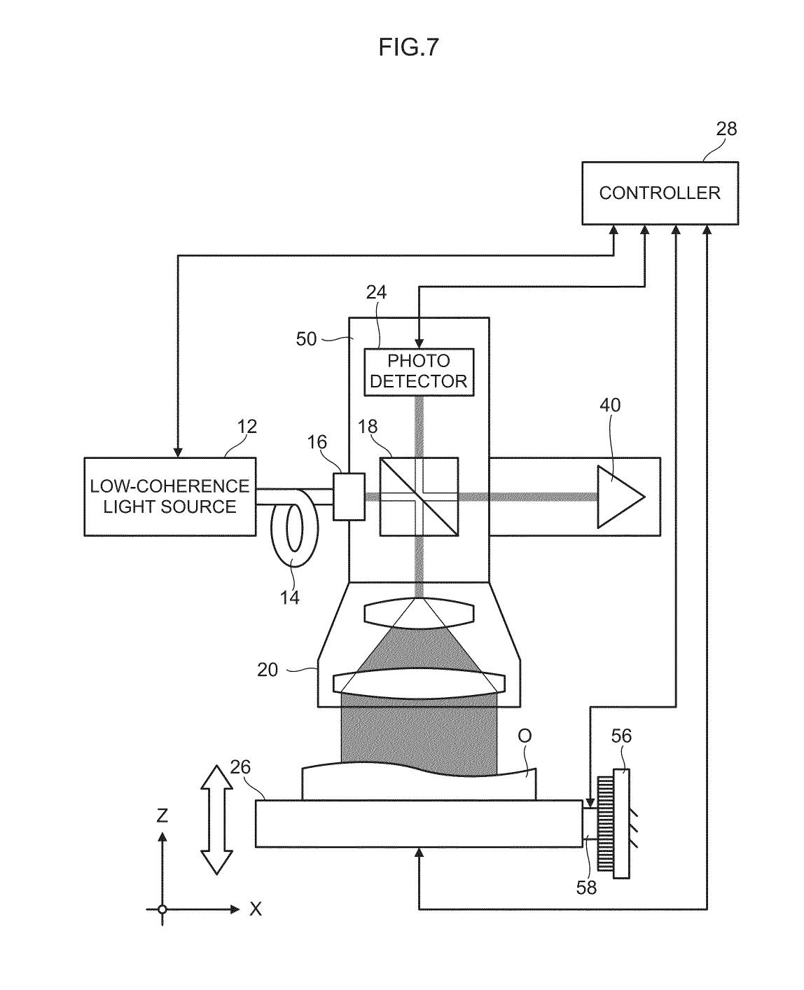

In the present embodiment, although the whole of the optical system is moved to change a difference between the optical path length of the measuring light and that of the reference light, it is also possible that the measuring object drive stage 26 is configured to be able to move up and down (movable in the Z-direction in FIG. 7) to move the measuring object O up and down (a configuration in which the measuring object is moved so as to keep parallelism and concentricity with respect to an optical axis of the measuring light emitted from the telecentric optical system 20), as shown in FIG. 7. In this case, the whole of the optical system is fixed. In addition, in this case, a height position (a position in the Z-direction in FIG. 7) of the measuring object drive stage 26 is detected by position detection means (composed of the linear scale 56, the scale head 58, and the like, for example) to detect a position of a measuring object.

### Another Embodiment

(1) Correction of Measurement Data

As described above, in the shape measuring device in accordance with the presently disclosed subject matter, the measuring light is expanded and parallelized by the telecentric optical system so that a measuring object is irradiated with the measuring light. Unfortunately, in a case where the measuring light is expanded and parallelized by the telecentric optical system so that a measuring object is irradiated with the measuring light, the optical path length of the measuring light deflected is changed to cause deviation of measurement data. Thus, in order to correct deviation of measurement data based on a deflection direction of the measuring light, correction data is acquired in advance so that the measurement data is corrected by using the correction data. Accordingly, it is possible to perform measurement with higher accuracy.

The correction data is created as follows: a reference surface of a reference article whose dimension is known (shape data (reference shape data) is known) is measured, and correction data for measurement data at each of measurement points is created from a result of the measurement. For example, a correction coefficient for correction is created by comparing measurement data acquired by measuring the reference article and the reference shape data of the reference article, and then the correction coefficient is used as the correction data.

The controller 28 performs the processing of creating the correction data before actual measurement is started, for example, and stores the correction data acquired in the storage device (correction information storage means). Then, at the time of the actual measurement, the controller 28 corrects acquired measurement data by using the correction data to calculate true measurement data.

As described above, in the actual measurement, since measurement of the reference surface is performed as advance preparation, it is preferable to create the correction data simultaneously with the measurement of the reference surface.

(2) Correction of Optical Path Length of Reference Light

As described above, when the measuring light is expanded and parallelized by the telecentric optical system, the optical path length of the measuring light is changed. Thus, it is possible to perform measurement with higher accuracy by changing also the optical path length of the reference light in accordance with the change in the optical path length of the measuring light caused by expanding and parallelizing the measuring light. That is, the optical path length of the reference light is changed so as to correspond to the change in the optical path length of the measuring light. Accordingly, it is possible to remove influence of expanding and parallelizing the measuring light.

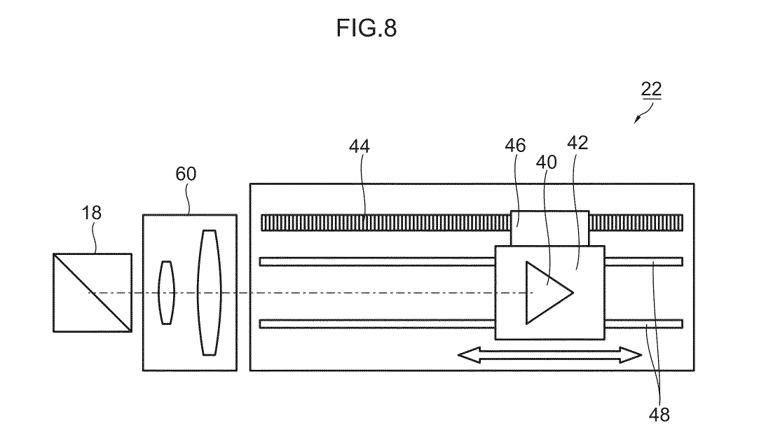

Here, it is possible to previously acquire how the optical path length of the measuring light is changed by being expanded and parallelized by the telecentric optical system. Thus, the optical path length of the reference light is corrected so as to change at the same variation as that of the optical path length of the measuring light. The correction is performed as follows: an optical system 60 for correction is arranged in an optical path of the reference light as shown in FIG. 8, for example, so that the optical path length of the reference light is corrected by the optical system 60 for correction.

(3) Another Example of Fractionation Means and Light Interference Means

In the embodiments described above, although a beam splitter is used as the fractionation means and the light interference means, an optical coupler and the like are available for the fractionation means and the light interference means, other than that.

(4) Another Example of Reference Light Reflector

In the embodiments described above, although a CCP is used as the reference light reflector, a corner cube mirror (CCM), a rectangular prism, and a rectangular mirror, are available for the reference light reflector, other than that.

(5) Measuring Object

According to the presently disclosed subject matter, it is possible to measure a dimension of a measuring object with high accuracy over a wide range. The measuring object is not particularly limited. In a low-coherence interference method, since it is possible to measure a multilayer film with layers of a different refractive index by allowing a light to penetrate a transparent body, measurement of a shape of an object covered with a film, transparent plastic, or the like, also can be performed.

(6) Photographing of Measuring Object

As described above, a solid imaging element, such as a CCD image sensor and a CMOS image sensor, is suitably used for the photodetector 24. In a case where this kind of solid imaging element is used for the photodetector 24, it is possible to acquire an image of a surface simultaneously with measurement of a shape of the surface. Thus, in a case where the solid imaging element is used for the photodetector 24, it is also possible to configure a shape measuring device in which an image of a surface whose shape is to be measured is taken simultaneously with measurement of the shape. Accordingly, it is possible to acquire not only three-dimensional shape data, but also image data on a surface whose three-dimensional shape data is acquired.

What is claimed is:

1. A shape measuring device that measures a three-dimensional shape of a surface of a measuring object, the shape measuring device comprising:
a light source configured to radiate low-coherence light;
a collimate optical system configured to convert the low-coherence light emitted from the light source into a parallel light;
a light splitting unit configured to split the low-coherence light parallelized by the collimate optical system into a measuring light and a reference light;
a reference light reflector configured to reflect the reference light emitted from the light splitting unit;
a reference light path length change unit configured to change an optical path length of the reference light by moving the reference light reflector;
a reference light reflector position detection unit configured to detect a position of the reference light reflector;
a telecentric optical system configured to expand and parallelize the measuring light emitted from the light splitting unit, and irradiate the measuring object with the measuring light;
a light interference unit configured to combine the reference light reflected from the reference light reflector and the measuring light reflected from the measuring object to allow the reference light and the measuring light to interfere with each other;
a light detection unit including light-receiving elements arranged in a matrix shape, the light detection unit configured to receive an interference light of the measuring light and the reference light, emitted from the light interference unit;
a calculation unit configured to detect a position of the reference light reflector at a time when an intensity of the interference light becomes maximum for each of the light-receiving elements and calculate a three-dimensional shape of a surface of the measuring object irradiated with the measuring light; and
an optical system for correction arranged between the reference light reflector and the light interference unit, the optical system for correction configured to correct the optical path length of the reference light so that the optical path length of the reference light is changed by a change corresponding to a change of the optical path length of the measuring light caused by expanding and parallelizing the measuring light with the telecentric optical system.

2. The shape measuring device according to claim 1, wherein the light source emits the low-coherence light whose center wavelength belongs to an ultraviolet light range.

3. The shape measuring device according to claim 2, wherein the telecentric optical system is composed of a both-side telecentric optical system.

4. The shape measuring device according to claim 3, wherein the light detection unit includes a solid imaging element, and
the shape measuring device further comprises a unit configured to obtain image data of the surface to be measured simultaneously with measurement of the three-dimensional shape.

5. A shape measuring device that measures a three-dimensional shape of a surface of a measuring object, the shape measuring device comprising:
a light source configured to radiate low-coherence light;
a collimate optical system configured to convert the low-coherence light emitted from the light source into a parallel light;
a light splitting unit configured to split the low-coherence light parallelized by the collimate optical system into a measuring light and a reference light;
a reference light reflector configured to reflect the reference light emitted from the light splitting unit;
a telecentric optical system configured to expand and parallelize the measuring light emitted from the light splitting unit, and irradiate the measuring object with the measuring light;
a light interference unit configured to combine the reference light reflected from the reference light reflector and the measuring light reflected from the measuring object to allow the reference light and the measuring light to interfere with each other;
a light detection unit including light-receiving elements arranged in a matrix shape, the light detection unit configured to receive an interference light of the measuring light and the reference light, emitted from the light interference unit;
a support body configured to movably support the collimate optical system, the light splitting unit, the reference light reflector, the light interference unit, the telecentric optical system, and the light detection unit, along an optical axis of the telecentric optical system;
a measuring light path length change unit configured to change an optical path length of the measuring light by moving the support body;
a support body position detection unit configured to detect a position of the support body;
a calculation unit configured to detect a position of the support body at a time when an intensity of the interference light becomes maximum for each of the light-receiving elements and calculate a three-dimensional shape of a surface of the measuring object irradiated with the measuring light; and
an optical system for correction arranged between the reference light reflector and the light interference unit, the optical system for correction configured to correct the optical path length of the reference light so that the optical path length of the reference light is changed by a change corresponding to a change of the optical path length of the measuring light caused by expanding and parallelizing the measuring light with the telecentric optical system.

6. The shape measuring device according to claim 5, wherein the light source emits the low-coherence light whose center wavelength belongs to an ultraviolet light range.

7. The shape measuring device according to claim 6, wherein the telecentric optical system is composed of a both-side telecentric optical system.

8. The shape measuring device according to claim 7, wherein the light detection unit includes a solid imaging element, and
the shape measuring device further comprises a unit configured to obtain image data of the surface to be measured simultaneously with measurement of the three-dimensional shape.

9. A shape measuring device that measures a three-dimensional shape of a surface of a measuring object, the shape measuring device comprising:
a light source configured to radiate low-coherence light;
a collimate optical system configured to convert the low-coherence light emitted from the light source into a parallel light;
a light splitting unit configured to split the low-coherence light parallelized by the collimate optical system into a measuring light and a reference light;
a reference light reflector configured to reflect the reference light emitted from the light splitting unit;
a telecentric optical system configured to expand and parallelize the measuring light emitted from the light splitting unit, and irradiate the measuring object with the measuring light;
a light interference unit configured to combine the reference light reflected from the reference light reflector and the measuring light reflected from the measuring object to allow the reference light and the measuring light to interfere with each other;
a light detection unit including light-receiving elements arranged in a matrix shape, the light detection unit configured to receive an interference light of the measuring light and the reference light, emitted from the light interference unit;
a support body configured to movably supports the measuring object along an optical axis of the telecentric optical system;
a measuring light path length change unit configured to change an optical path length of the measuring light by moving the measuring object;
a measuring object position detection unit configured to detect a position of the measuring object;
a calculation unit configured to detect a position of the measuring object at a time when an intensity of the interference light becomes maximum for each of the light-receiving elements and calculate a three-dimensional shape of a surface of the measuring object irradiated with the measuring light; and
an optical system for correction arranged between the reference light reflector and the light interference unit, the optical system for correction configured to correct the optical path length of the reference light so that the optical path length of the reference light is changed by a change corresponding to a change of the optical path length of the measuring light caused by expanding and parallelizing the measuring light with the telecentric optical system.

10. The shape measuring device according to claim 9, wherein the light source emits the low-coherence light whose center wavelength belongs to an ultraviolet light range.

11. The shape measuring device according to claim 10, wherein the telecentric optical system is composed of a both-side telecentric optical system.

12. The shape measuring device according to claim 11, wherein the light detection unit includes a solid imaging element, and
the shape measuring device further comprises a unit configured to obtain image data of the surface to be measured simultaneously with measurement of the three-dimensional shape.
